(19) United States
(12) Patent Application Publication
(10) Pub. No.: US 2012/0114130 A1
(43) Pub. Date: May 10, 2012

(54) COGNITIVE LOAD REDUCTION

(75) Inventor: Andrew Lovitt, Redmond, WA (US)

(73) Assignee: Microsoft Corporation, Redmond, WA (US)

(21) Appl. No.: 12/942,799

(22) Filed: Nov. 9, 2010

(51) Int. Cl. H04R 3/02; G10L 13/08

(52) U.S. Cl. 381/73.1; 704/260; 704/E13.011

(57) ABSTRACT

A cognitive load reduction system comprises a sound source position decision engine configured to receive one or more audio signals from a corresponding one or more signal generators, wherein the sound source position decision engine is further configured to identify two or more discrete sound sources within at least one of the one or more audio signals. The cognitive load reduction system further comprises an environmental assessment engine configured to assess environmental sounds within an environment. The cognitive load reduction system further comprises a sound location engine configured to output one or more audio signals configured to cause a plurality of speakers to change a perceived location of at least one of the discrete sound sources within the environment responsive to locations of other sounds within the environment.

### BACKGROUND

A user may experience many different sounds within a use environment, and such sounds may originate from a variety of sources. When multiple sound sources are present, the load on the user's working memory (e.g., the cognitive load) may increase as the user attempts to distinguish and process the different sounds. In particular, such a cognitive load may further increase in situations wherein the user lacks visual indications to aid in distinguishing and identifying the sounds, such as during a phone conversation, for example. Since an increased cognitive load may result in distraction, it may be desirable to reduce the cognitive load of the user when multiple sounds are present, and thus enhance the user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, cognitive load reduction is provided by a system comprising a sound source position decision engine configured to receive one or more audio signals from a corresponding one or more signal generators, wherein the sound source position decision engine is further configured to identify two or more discrete sound sources within at least one of the one or more audio signals. The cognitive load reduction system further comprises an environmental assessment engine configured to assess environmental sounds within an environment. The cognitive load reduction system further comprises a sound location engine configured to output one or more audio signals configured to cause a plurality of speakers to change a perceived location of at least one of the discrete sound sources within the environment responsive to locations of other sounds within the environment.

### BRIEF DESCRIPTION OF THE DRAWINGS

FIG. 1 shows an example environment in accordance with an embodiment of the present disclosure.

FIG. 2 shows an example cognitive load reduction system.

FIG. 3 shows a flow diagram of an example method of cognitive load reduction.

FIG. 4 shows an example of changing perceived locations of voices in accordance with an embodiment of the present disclosure.

FIG. 5 shows an example of changing perceived locations in a vehicle cabin in accordance with an embodiment of the present disclosure.

### DETAILED DESCRIPTION

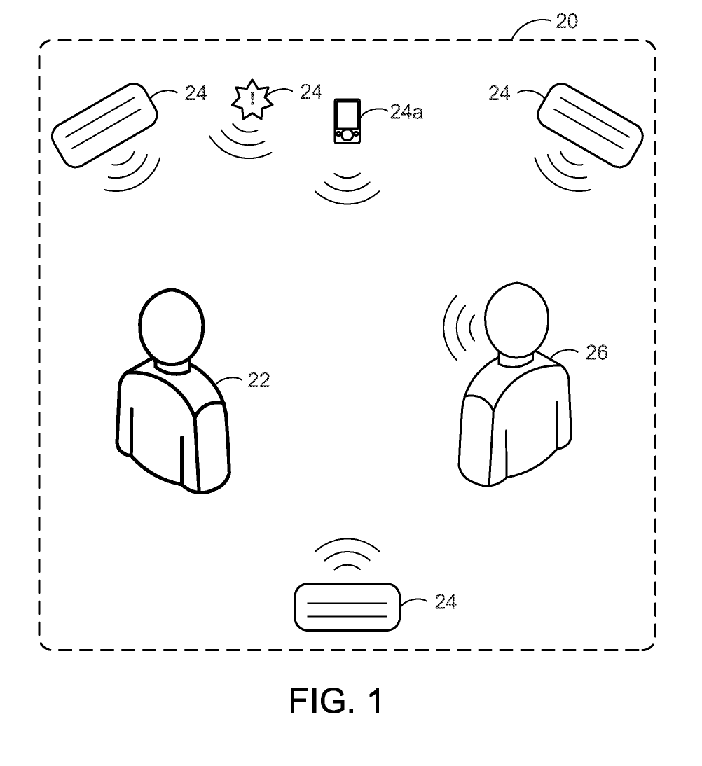

A user may experience multiple sounds in a use environment from a variety of sources such as a mobile phone, a media player, a computer, other people, etc. As a nonlimiting example, FIG. 1 shows an example environment 20 in which a user 22 experiences sound from a variety of discrete sound sources 24, including a mobile communication device 24a. User 22 also experiences environmental sounds, such as the voice of another person 26. Distinguishing and processing sound from each of sound sources 24, as well as the environmental sounds, may increase the cognitive load of user 22, and may even distract user 22. As a nonlimiting example, such an environment 20 may be a vehicle cabin. In such an example, user 22 may be driving the vehicle, and person 26 may be a passenger in the vehicle. Further, sound sources 24 may corresponds to vehicle components such as a notification system, a navigation system, etc., and mobile device 24a may be a mobile phone providing an audio stream of a phone conversation. As such, it may be desirable to reduce the cognitive load, and thus the distraction, of the driver.

Therefore, embodiments are disclosed herein that relate to cognitive load reduction, and in particular, to changing the perceived locations of sound sources so as to reduce the cognitive load of the user. The perceived location of a sound source may be changed by adjusting the relative volumes, phases, delays, and/or other attributes of one or more audio streams through one or more speakers. It should be appreciated that FIG. 1 is intended to be illustrative and not limiting in any manner.

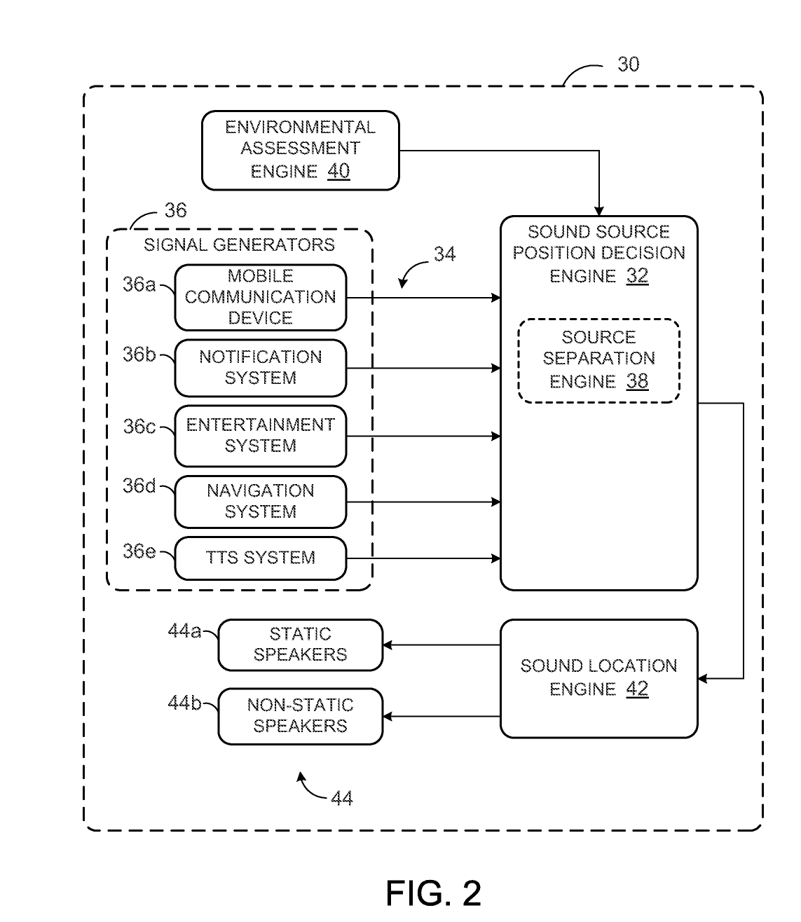

Turning now to FIG. 2, FIG. 2 illustrates an example cognitive load reduction system 30. Cognitive load reduction system 30 includes a sound source position decision engine 32 configured to receive one or more audio signals 34 from a corresponding one or more signal generators 36. Examples of such signal generators 36 include, but are not limited to, a mobile communication device 36a, a notification system 36b, an entertainment system 36c, a navigation system 36d, and a text-to-speech (TTS) system 36e. Such input audio streams may be received via any suitable mechanism and/or protocol. Further, it should be appreciated that multiple phones, TTS, notification systems, etc. may be connected at a same time.

Sound source position decision engine 32 may be further configured to identify two or more discrete sound sources within one or more of the audio signals 34. In some embodiments, a source separation engine 38 may aid in such identification. As an example, for the case of the audio signal received from mobile communication device 36a, such an audio signal is a mobile communication stream (e.g., a phone conversation). Such a phone conversation may be with a single caller or multiple callers. As such, the discrete sound sources may include one or more discrete voices in the mobile communication stream, such as a first caller, a second caller, etc. Accordingly, source separation engine 38 may aid in identifying each caller within the stream.

Two or more discrete sound sources may be identified within a single audio signal using any suitable method. In some embodiments, the audio signal may include metadata and/or other identifiers identifying different sound sources. In some embodiments, the audio signal may not include any information or clues as to the various sound sources present in the signal. In such embodiments, the audio signal may be processed to identify the different sound sources. This may be done via pitch detection and separation, voice recognition algorithms, signal processing, and/or any other suitable method.

Sound source position decision engine 32 may be configured to place new streams and content when the stream is activated. Further, in some embodiments, sound source position decision engine 32 may make various determinations, such as whether or not to move a source spatially, whether there is speech in the current stream, where to move the source (e.g., based on which other sources are active and/or which user should hear the source, etc.), etc. Further yet, sound source position decision engine 32 may be configured to create a set of parameters used for signal processing at a sound location engine 42.

Cognitive load reduction system 30 may further include an environmental assessment engine 40 configured to assess environmental sounds within the environment. As an example, environmental assessment engine 40 may include a controller configured to track signal generators 36 and/or a microphone for interrogating the environment. For example, in a noisy environment, the user may not necessarily be interested in a notification from a peripheral source (e.g., a social-networking application). As such, cognitive load reduction system 30 may suppress such a notification based on the state of the environment. In some embodiments, in addition to assessing a current state of the environment, environmental assessment engine 40 may be further configured to assess an initial state of the environment. Cognitive load reduction system 30 may then use such initial environment information for performing various calibrations, such as calibrating one or more speakers, etc.

Cognitive load reduction system 30 further includes a sound location engine 42 configured to output one or more audio signals. In particular, sound location engine 42 outputs the audio signals in such a way to cause speakers 44 to change a perceived location of at least one of the discrete sound sources within the environment responsive to locations of other sounds (e.g., other discrete sound sources of audio signals 34, environmental sounds, etc.) within the environment.

The perceived location of a particular sound is the location from where the user perceives the sound to be originating. Knowing where a particular sound originates in space provides the user with spatial cues which aid the user's brain in processing the sound. When multiple sound sources are present, the user may rely on such spatial cues to distinguish and process the different sound sources. Thus, manipulating the perceived auditory location of an auditory source may aid the user's brain in performing source separation, and thus may reduce the cognitive load of the user.

Speakers 44 may change the perceived location by manipulating aspects of the audio signals including but not limited to signal magnitude, a signal phase, a signal phase on a per-frequency basis, etc. Further, in some embodiments an entire stream may be delayed, and/or the signal may be filtered to compensate for the room response. As a nonlimiting example, a spatial source may be playing the sound source through a left speaker 1 ms after playing in the right speaker. This creates the impression that the source is closer to the right speaker. With a larger number of speakers, the placement may be further refined.

As another example, the audio streams may be moved around continuously to create a clear spatial cue. For example, in the case of the vehicle scenario, audio streams may be placed at locations of the car seats to provide the illusion of the stream being sourced from a person sitting at that seat. Further, other speakers in addition to the vehicle speakers may be utilized to further enhance the audio experience. For example, headphones may be utilized to provide specific user audio spatial separation.

Sound location engine 42 may be configured to output audio signals to cause speakers 44 to change a perceived location in any suitable way. For example, sound location engine 42 may be configured to provide signal processing for speaker delays and stream mixing, and then provide the signals to speakers 44. Such speakers may include static speakers 44a (e.g., speakers at fixed locations within the environment), and/or non-static speakers 44b, such as headphone speakers, wireless Internet speakers, etc. Such signal processing of sound location engine 42, and source separation performed by source separation engine 38, may be particularly useful for digital signal processing (DSP).

It should be appreciated that the herein described sound analysis and perceived location adjustments may be performed via hardware and/or software. In some embodiments, the low level signal processing may be provided by a hardware specific implementation, a DSP implementation, and/or a software implementation. For example, DSP algorithms may be utilized for moving the audio streams to different spatial locations via the speakers. Since the inputs are typically software or hardware streams, the hardware may be configured to operate on such streams. This is in contrast to all hardware streams wherein a software solution would digitize all signals before manipulation.

Further, in some embodiments, performing such adjustments may include determining a weighting factor for each speaker based on the listener (e.g., the user) for each stream. For example, in some embodiments, the fixed speaker locations may be utilized to pre-compute weighting tables which allow for the swift run-time performance of these algorithms in software and/or hardware. In this way, the placement of the audio stream can be implemented by a more sophisticated mixer which allows for gain adjustments, phase delays, filtering, etc. As another example, the system may allow for frequency selective gains which take into account the specific response of the cabin.

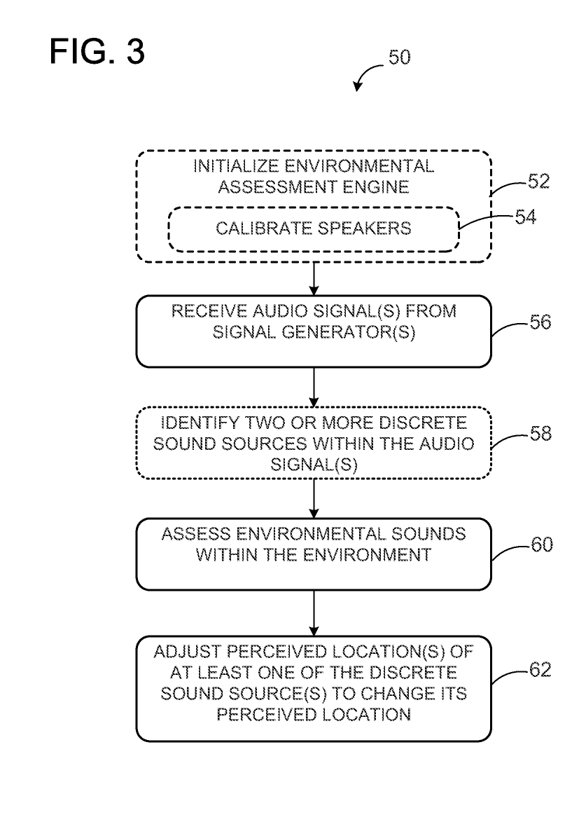

Turning now to FIG. 3, FIG. 3 illustrates an example method 50 of cognitive load reduction. At 52, method 50 includes initializing the environmental assessment engine. This may include performing various calibrations to determine an initial state of the environment. As such, the system can determine, for example, the distance from the user to each speaker, etc. so that the system can determine how sound is perceived by the user. In some embodiments, such initialization may include, for example, calibrating one or more speakers, as indicated at 54. For the case where the environment is a vehicle cabin, this may include calibrating the vehicle's speakers to account for objects within the vehicle that may affect how sound is perceived by the driver, for example. It should be appreciated that such initialization is nonlimiting, and in some embodiments, the cognitive load reduction system may precompute such parameters for known locations.

At 56, method 50 includes receiving (e.g., at a sound source position decision engine) audio signals from one or more signal generators. It should be appreciated that such signal generators may be any suitable signal generators configured to provide an audio signal comprising one or more streams. Nonlimiting examples of suitable signal generators include mobile phones, media players, computers, etc. For the case of the environment being a vehicle cabin, such signal generators may include one or more vehicle signal generators such as a notification system, a navigation system, an entertainment system, etc.

At 58, method 50 may optionally include identifying two or more discrete sound sources within one or more audio signals. For the case of a phone conversation, this may include identifying discrete voices in the mobile communication stream, such as a first caller, a second caller, etc.

At 60, method 50 includes assessing environmental sounds within the environment. Environmental sounds may include virtually any other sounds in the environment, such as passenger voices, etc.

At 62, method 50 includes changing a perceived location of at least one of the discrete sound sources. This may include placing audio events and/or streams (e.g., phone conversations, music, notifications, text-to-speech, etc.) at different places in the auditory field (e.g., the environment). As such, the sound source is perceived by a user as originating from that location.

It should be appreciated that the perceived locations may be changed in any suitable manner. For example, a sound location engine may be utilized to perform such adjustments and output the signals to speakers. In some embodiments, the sound location engine may change the perceived location by outputting the signal to a different speaker location. However, in some embodiments, the sound location engine may be configured to adjust relative amplitudes of the plurality of speakers to change the perceived location. Further, in some embodiments, the sound location engine may be configured to adjust relative delays of the plurality of speakers to change the perceived location.

For the case of a phone conversation, changing the perceived location of the sound source at 62 may include spatially separating (e.g., via a sound separation engine) a perceived location of each of the discrete voices in the mobile communication stream. Further, in some embodiments, the sound source position decision engine may be configured to determine a prioritization of the discrete voices based on an activity level of each of the discrete voices within the mobile communication stream (e.g., talkative callers having a greater priority over less-talkative callers). As such, the sound location engine may spatially separate the discrete voices based on the prioritization (e.g., placing talkative callers at a more prominent perceived location, such as the passenger seat of a vehicle cabin, and less talkative callers in less prominent perceived locations, such as the back seat of a vehicle cabin). It should be appreciated that such separation based on prioritization is not limited to conference calls. As another example, the system may move music played in a vehicle to the backseat while the front seat is in a conference call. In such a case, the music may be moved to the rear speakers and the front speakers may be used to place the participants in the phone call, for example.

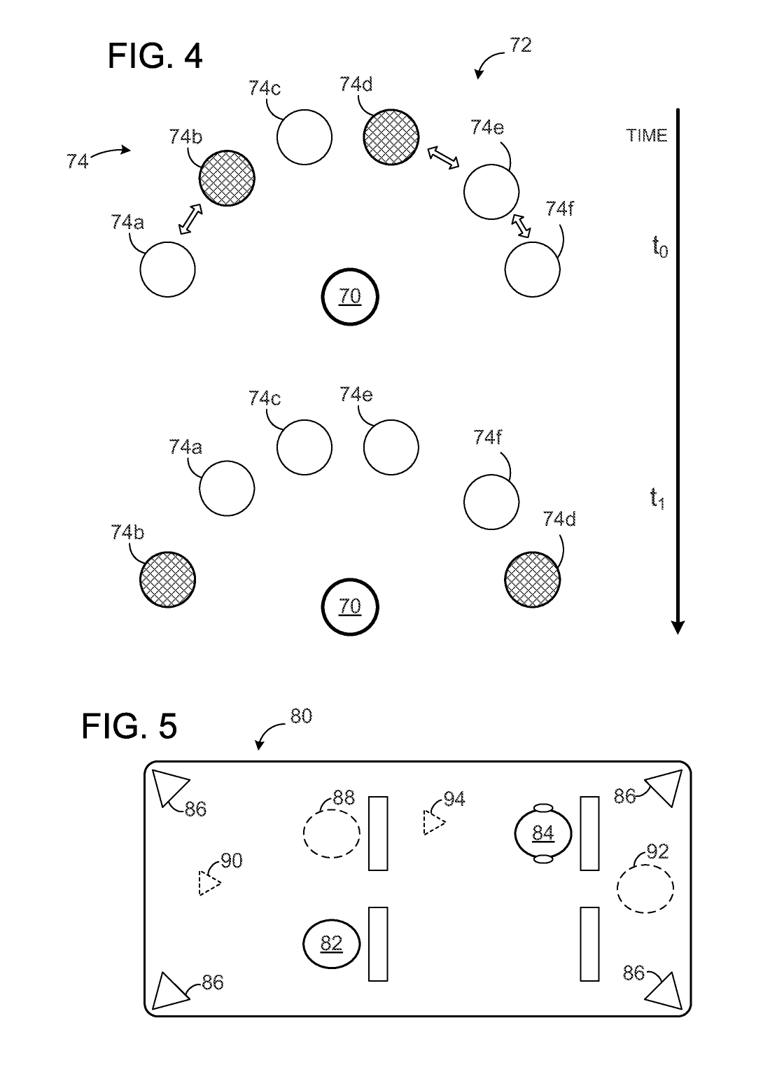

FIG. 4 illustrates changing perceived locations for voices in a conference call. In this example, a user 70 is in a conference call 72 with six discrete voices 74. In this example, the conversation is primarily dominated by two voices, namely voice 74b and voice 74d. In other words, voice 74b and voice 74d have more activity in the conversation (e.g., more talkative) than the other voices, namely voice 74a, voice 74c, voice 74e and voice 74f. As such, the spatial environment of the situation depicted at time to is not separated to produce the smallest cognitive load for user 70. This is because the perceived locations of the two dominant talkers, voice 74b and voice 74d, are located in close proximity to one another, and thus user 70 may not have the spatial cues to help distinguish between the two voices.

Accordingly, the cognitive reduction system may swap a perceived location of voice 74a and a perceived location of voice 74b, as well as swapping perceived locations of voice 74d and voice 74f with a minor swap with voice 74e. This may be done slowly so as to not distract user 70 (e.g., the driver, in the case of a vehicle scenario). Thus, at subsequent time ti, the perceived locations of the two dominant talkers, voice 74b and voice 74d, are spatially separated to a larger degree with respect to one another. Separating the dominant sound sources in this way allows the cognitive reduction system to keep the auditory field sparsely populated with individual sources, and thus reduces the cognitive load for user 70.

In some embodiments, the sound location engine may change perceived locations responsive to content of the one or more audio signals, user feedback, a predetermined prioritization of the one or more audio signals, etc. Further, as described above, the sound location engine may be configured to determine weighting factors for one or more of the speakers to change the perceived location of the one of the discrete sound sources within the environment.

In particular, for the case of the environment being a vehicle cabin, the sound source position decision engine may be configured to receive audio signal(s) from a corresponding one or more vehicle components, such as a notification system, a communication system, an entertainment system, a navigation system, a text-to-speech system, etc. The sound location engine may then output audio signal(s) configured to cause speakers within a vehicle cabin to set a perceived location of other vehicle components (e.g., different ones of the one or more vehicle components) at different locations within the vehicle cabin.

Further, in some embodiments, the sound location engine may be configured to change perceived locations responsive to locations of sounds from passengers in the vehicle. Moreover, in some embodiments, a perceived location of an audio signal may be set based on a predetermined prioritization of the audio signal with respect to the other audio signals. For example, audio signals from the notification system may have priority over audio signals from the entertainment system.

As another example, streams associated with a notification system may be placed in front of the driver, where a driver may be used to looking for other notifications provided by the notification system, such as visual alerts. In some embodiments, such streams associated with the notification system may be placed at distinct acoustic points so that a warning can have an acoustically pronounced direction as well.

As another example, phone conversations may be placed in passenger seats of the vehicle, where a driver is used to conversing with physical passengers. Further, stream separation performed at 58 of FIG. 3 allows for different callers on a multiple-person phone call to be placed at different perceived locations. This allows the user to distinguish the voices by using the spatial cues provided by the different perceived locations, thus reducing the user's cognitive load.

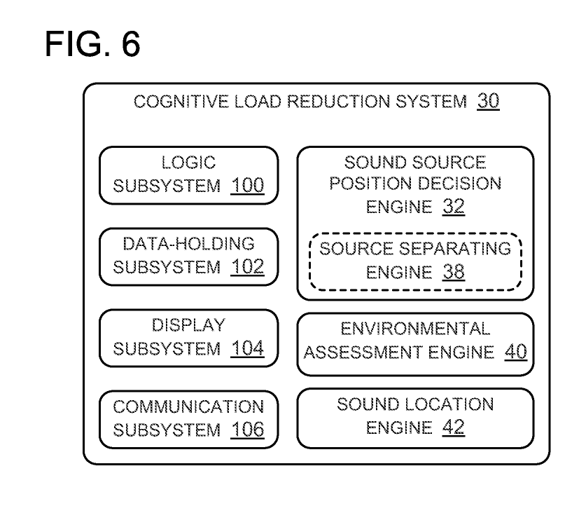

FIG. 5 shows an example of changing perceived locations in a vehicle cabin 80. FIG. 5 depicts a driver 82 of the vehicle, wherein vehicle cabin 80 further includes a rear passenger 84. The perceived locations of sound sources may be changed via a cognitive reduction system so as to spatially separate the signals for driver 82, and thus reduce driver distraction by the audio sources.

In this example, vehicle speakers 86 configured to output audio signals from various components are positioned throughout the interior of the vehicle (e.g., at each of the four corners). Further, the cognitive reduction system may position a cell phone conversation to have a perceived location 88 of the passenger seat. In this way, driver 82 perceives the caller to be located in the passenger seat, wherein the driver may be used to conversing with a physical passenger.

Navigation commands from a navigation system may be positioned to have a perceived location 90 at a center of the dash in front of driver 82, where other vehicle notifications typically are displayed (e.g., speed limit warnings, seatbelt warnings, notifications of incoming calls, etc.).

Such organization of sound sources creates a spatially different cue for each source, aiding the driver's recognition of each stream. Further, rear passenger 84 may also have an enhanced audio experience provided by cognitive reduction system. For example, rear passenger 84 may listen to music and TTS from different perceived locations, as indicated at 92 and 94 respectively. For example, rear passenger 84 may listen to music via non-fixed portable speakers such as headphones which are communicatively coupled with a sound source at the back of the car as indicated at 92, whereas the TTS system is in front of him at 94, near the screen for the video he is watching. By separating the TTS system, rear passenger 84 may, for example, make a selection via voice commands and the TTS response will not be spatially mixed with music. Further, rear passenger 84 need not stop his music to listen to a TTS notification. Moreover, such a configuration may aid in preventing the TTS and music from his headphones from distracting driver 82.

In some embodiments, the above described methods and processes may be tied to a cognitive reduction system including one or more computers. In particular, the methods and processes described herein may be implemented as a computer application, computer service, computer API, computer library, and/or other computer program product.

FIG. 6 schematically shows a nonlimiting cognitive reduction system 30 that may perform one or more of the above described methods and processes. Cognitive reduction system 30 is shown in simplified form. It is to be understood that virtually any computer architecture may be used without departing from the scope of this disclosure. In different embodiments, cognitive reduction system 30 may take the form of a vehicle computer, server computer, desktop computer, laptop computer, tablet computer, home entertainment computer, network computing device, mobile computing device, mobile communication device, gaming device, a cloud service, etc.

Cognitive reduction system 30 includes a logic subsystem 100 and a data-holding subsystem 102. Cognitive reduction system 30 may optionally include a display subsystem 104, a communication subsystem 106, and/or other components not shown in FIG. 6. Cognitive reduction system 30 may also optionally include user input devices such as keyboards, mice, game controllers, cameras, microphones, and/or touch screens, for example.

Logic subsystem 100 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 102 may include one or more physical, non-transitory, devices configured to hold data and/or instructions executable by the logic subsystem to implement the herein described methods and processes. When such methods and processes are implemented, the state of data-holding subsystem 102 may be transformed (e.g., to hold different data).

Data-holding subsystem 102 may include removable media and/or built-in devices. Data-holding subsystem 102 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 102 may include devices with one or more of the following characteristics: volatile, nonvolatile, dynamic, static, read/write, read-only, random access, sequential access, location addressable, file addressable, and content addressable. In some embodiments, logic subsystem 100 and data-holding subsystem 102 may be integrated into one or more common devices, such as an application specific integrated circuit or a system on a chip.

As described above, the cognitive load reduction system may include a sound source position decision engine 32, a source separation engine 38, and environmental assessment engine 40, and a sound location engine 42. Aspects of these components may be implemented via logic subsystem 100 and/or data-holding subsystem 102. In some embodiments, one or more of these components may be implemented with shared hardware, firmware, and/or software, and in other embodiments each component may be implemented with discrete hardware, firmware, and/or software.

The terms “module,” “program,” and “engine” may be used to describe an aspect of cognitive reduction system 30 that is implemented to perform one or more particular functions. In some cases, such a module, program, or engine may be instantiated via logic subsystem 100 executing instructions held by data-holding subsystem 102. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 104 may be used to present a visual representation of data held by data-holding subsystem 102. As the herein described methods and processes change the data held by the data-holding subsystem, and thus transform the state of the data-holding subsystem, the state of display subsystem 104 may likewise be transformed to visually represent changes in the underlying data. Display subsystem 104 may include one or more display devices utilizing virtually any type of technology. Such display devices may be combined with logic subsystem 100 and/or data-holding subsystem 102 in a shared enclosure, or such display devices may be peripheral display devices.

When included, communication subsystem 106 may be configured to communicatively couple cognitive reduction system 30 with one or more other computing devices. Communication subsystem 106 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow cognitive reduction system 30 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A cognitive load reduction system, comprising:
a sound source position decision engine configured to receive one or more audio signals from a corresponding one or more signal generators, the sound source position decision engine configured to identify two or more discrete sound sources within at least one of the one or more audio signals;
an environmental assessment engine configured to assess environmental sounds within an environment; and
a sound location engine configured to output one or more audio signals configured to cause a plurality of speakers to change a perceived location of at least one of the discrete sound sources within the environment responsive to locations of other sounds within the environment.

2. The cognitive load reduction system of claim 1, wherein the one of one or more audio signals is a mobile communication stream and the two or more discrete sound sources are discrete voices in the mobile communication stream.

3. The cognitive load reduction system of claim 2, wherein the sound location engine is configured to spatially separate a perceived location of each of the discrete voices in the mobile communication stream.

4. The cognitive load reduction system of claim 3, wherein the sound source position decision engine is configured to determine a prioritization of the discrete voices based on an activity level of each of the discrete voices within the mobile communication stream, and wherein the sound location engine is configured to spatially separate based on the prioritization.

5. The cognitive load reduction system of claim 1, wherein the sound location engine is configured to adjust relative amplitudes of the plurality of speakers to change the perceived location of the one of the discrete sound sources within the environment.

6. The cognitive load reduction system of claim 1, wherein the sound location engine is configured to adjust relative delays of the plurality of speakers to change the perceived location of the one of the discrete sound sources within the environment.

7. The cognitive load reduction system of claim 1, wherein the sound location engine is configured to cause the plurality of speakers to change the perceived location of at least one of the discrete sound sources within the environment further responsive to content of the one or more audio signals.

8. The cognitive load reduction system of claim 1, wherein the sound location engine is configured to cause the plurality of speakers to change the perceived location of at least one of the discrete sound sources within the environment further responsive to user feedback.

9. The cognitive load reduction system of claim 1, wherein the sound location engine is configured to determine weighting factors for one or more of the plurality of speakers to change the perceived location of the one of the discrete sound sources within the environment.

10. The cognitive load reduction system of claim 1, wherein the environment is a vehicle cabin.

11. The cognitive load reduction system of claim 10, wherein the sound location engine is configured to output one or more audio signals configured to cause the plurality of speakers to change the perceived location of at least one of the discrete sound sources within the environment further responsive to locations of sounds from one or more passengers in the vehicle cabin.

12. The cognitive load reduction system of claim 1, wherein the sound location engine is configured to cause the plurality of speakers to change the perceived location of at least one of the discrete sound sources within the environment further responsive to a predetermined prioritization of the one or more audio signals.

13. A vehicle cognitive load reduction system, comprising:
a sound source position decision engine configured to receive one or more audio signals from a corresponding one or more vehicle components; and
a sound location engine configured to output one or more audio signals configured to cause a plurality of speakers within a vehicle cabin to set a perceived location of different ones of the one or more vehicle components at different locations within the vehicle cabin.

14. The vehicle cognitive load reduction system of claim 13, wherein a perceived location of an audio signal is set based on a predetermined prioritization of the audio signal with respect to the other audio signals.

15. The vehicle cognitive load reduction system of claim 13, wherein the one or more vehicle components includes a notification system.

16. The vehicle cognitive load reduction system of claim 13, wherein the one or more vehicle components includes a communication system.

17. The vehicle cognitive load reduction system of claim 13, wherein the one or more vehicle components includes an entertainment system.

18. The vehicle cognitive load reduction system of claim 13, wherein the one or more vehicle components includes a navigation system.

19. The vehicle cognitive load reduction system of claim 13, wherein the one or more vehicle components includes a text-to-speech system.

20. In a vehicle cabin, a method of prioritizing sound for a driver, the method comprising:
using a plurality of speakers within the vehicle cabin to place a perceived location of a first of a two or more sound sources at a first location within the vehicle cabin; and
using the plurality of speakers to place a perceived location of a second of the two or more sound sources at a second location within the vehicle cabin, the first location and the second location being spatially separated from one another and from any of the plurality of speakers.
